(19) United States
(12) Patent Application Publication
(10) Pub. No.: US 2010/0103454 A1
(43) Pub. Date: Apr. 29, 2010

(54) Image Forming Method, Image Forming Apparatus, and Image Forming System

(75) Inventors: Takeharu TOGUCHI, Matsumoto-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/581,706

(22) Filed: Oct. 19, 2009

(30) Foreign Application Priority Data
Oct. 24, 2008 (JP) 2008-274647

(51) Int. Cl. G06F 15/00

(52) U.S. Cl. 358/1.15

(57) ABSTRACT

An image forming method includes: dividing input image data; transmitting first divided data to a first image processing unit; transmitting second divided data to a second image processing unit; image-processing the first divided data transmitted to the first image processing unit; image-processing the second divided data transmitted to the second image processing unit; and forming an image based on the first divided data image-processed by the first image processing unit and the second divided data image-processed by the second image processing unit.

### BACKGROUND

1. Technical Field

The present invention relates to an image forming method, an image forming apparatus, and an image forming system in which an electrostatic latent image is formed on a latent image carrier by a line head having arranged light emitting devices.

2. Related Art

Known devices include a conventional image forming apparatus such as a printer, an image forming apparatus that forms an electrostatic latent image on a latent image carrier, i.e. a photoreceptor using a line head having arranged light emitting devices such as organic EL devices (for example, refer to JP-A-2008-137237). In the image forming apparatus disclosed in JP-A-2008-137237, an image processing controller image-processes image data contained in an image forming instruction to form video data. Further, a head controller turns on or off light emitting devices of a line head based on the video data to form an electrostatic latent image on a latent image carrier.

However, in recent years, an image forming apparatus using a line head has required higher speed and higher resolution. Accordingly, an image needs to be processed at a high speed. Meanwhile, the amount of image-processed data accompanied by a high resolution becomes greater, making it difficult to process an image at a high speed. Moreover, an image forming apparatus needs to be general purpose so as to flexibly cope with various high resolutions.

However, the image forming apparatus disclosed in JP-A-2008-137237 is not general purpose and cannot flexibly cope with various resolutions. Further, since data is communicated between an image processing controller and a head controller in a one-to-one manner, it is difficult to process an image at a higher speed.

### SUMMARY

An advantage of some aspects of the invention is that it provides an image forming method, an image forming apparatus, and an image forming system that can flexibly cope with various resolutions, and effectively processes an image at a higher speed.

In an image forming method, an image forming apparatus, and an image forming system according to the invention, input image data is divided. First divided data is image-processed by a first image processing unit and second divided data is image-processed by a second image processing unit. An image is formed based on the first divided data and the second divided data that are image-processed.

Therefore, image-processing of the first divided data and the second divided data obtained by dividing the image data is distributed. Accordingly, image data of a high resolution and a high capacity can more promptly be processed. In particular, an image can be processed by a high speed image forming engine in real time. Accordingly, various high resolutions required by an image forming apparatus can flexibly be coped with, thereby processing the image at a higher speed.

### BRIEF DESCRIPTION OF THE DRAWINGS

The invention will be described with reference to the accompanying drawings, wherein like reference numbers represent like elements.

FIG. 1 is a view schematically and partially illustrating an image forming apparatus according to an embodiment of the invention.

FIG. 2 is a partial perspective view of a line head of FIG. 1.

FIG. 3 is a block diagram of an engine control unit and an engine unit of FIG. 1.

FIG. 4 is a view illustrating an example of divided image data.

FIG. 5 is a block diagram illustrating processing of image data in a head control module.

FIG. 6 is a flowchart illustrating formation of an image based on image data.

FIG. 7 is a block diagram of an engine control unit and an engine unit in an image forming apparatus according to another embodiment of the invention.

### DESCRIPTION OF EXEMPLARY EMBODIMENTS

Hereinafter, exemplary embodiments of the invention will be described with reference to the accompanying drawings.

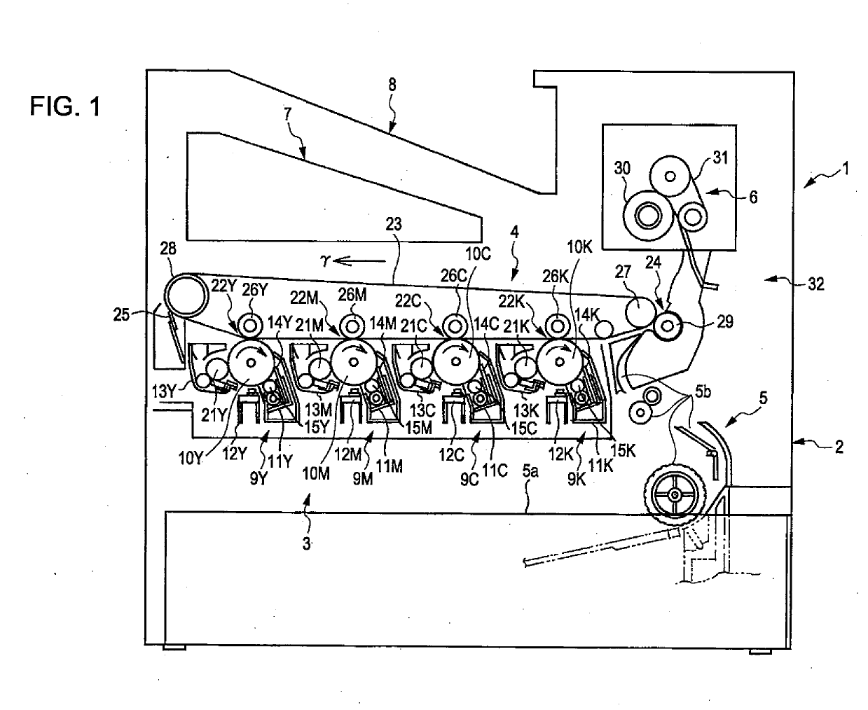

FIG. 1 is a view schematically and partially illustrating an image forming apparatus according to an embodiment of the invention.

As illustrated in FIG. 1, the image forming apparatus 1 includes a housing body 2. An image forming unit 3, a transfer unit 4, a transfer material supply unit 5 accommodating a transfer material such as a transfer paper, a fuser unit 6, an engine control unit 7, and a paper discharge tray 8 are provided in the housing body 2.

The image forming unit 3 includes a first image forming station 9Y that is an image forming station for yellow Y, a second image forming station 9M that is an image forming station for magenta M, a third image forming station 9C that is an image forming station for cyan C, and a fourth image forming station 9K that is an image forming station for black K. The first to fourth image forming stations 9Y, 9M, 9C, and 9K are sequentially disposed at random. The disposing order of the first to fourth image forming stations 9Y, 9M, 9C, and 9K is arbitrary. Hereinafter, the image forming unit 3 will be described in the disposing order of the first to fourth image forming stations 9Y, 9M, 9C, and 9K.

The first to fourth image forming stations 9Y, 9M, 9C, and 9K have the same structure. Therefore, the first image forming station 9Y for yellow Y will be described, but a detailed description of the second to fourth image forming stations 9M, 9C, and 9K for the other colors will be omitted. The elements of the second to fourth image forming stations 9M, 9C, and 9K are endowed with the same reference numerals as those of the elements of the first image forming station 4Y for yellow Y and the symbols of M, C, and K.

The first image forming station 9Y includes a first photoreceptor 10Y that is a latent image carrier. The first image forming station 9Y further includes a first charging section 11Y, a first line head 12Y that is an image recording section, a first developing section 13Y, and a first photoreceptor cleaner 14Y, around the first photoreceptor 10Y.

The first charging section 11Y has a conventionally well-known first charging roller 15Y. The first charging roller 15Y charges the surface of the first photoreceptor 10Y to a preset surface potential.

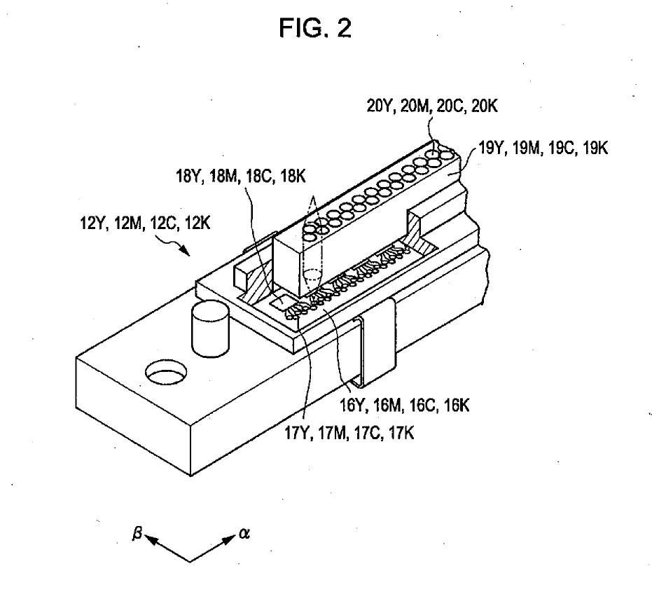

As illustrated in FIG. 2, the first line head 12Y has a first base substrate 16Y, first LED arrays 17Y, first driver ICs 18Y, a first rod lens array 19Y. The first LED array 17Y has LED devices that are light emitting devices. In this case, the LED devices are provided along a first direction (i.e. main scanning direction) a perpendicular or substantially perpendicular to the transport direction (movement direction) of a transfer material on the first base substrate 16Y.

The first driver ICs 18Y are provided adjacent to the LED devices along a second direction (i.e. sub-scanning direction) β the same as or substantially the same as the transport direction of a transfer material on the first base substrate 16Y and are also provided along the first direction α. Then, a preset number of LED devices are connected to one first driver IC 18Y. Therefore, the first driver IC 18Y drives the LED devices connected thereto. In this case, in the LED devices, a video signal is provided by a below-described head controller 36, the first driver IC 18Y is driven to emit light based on the video signal.

The first rod lens array 19Y has first refractive index distributed rod lenses 20Y. The first refractive index distributed rod lenses 20Y are provided in two rows in zigzags along the first direction a and oppose the LED devices. The first refractive index distributed rod lenses 20Y optically form an image using the light from the LED devices to expose the first photoreceptors 10Y to light, and forms an electrostatic latent image for yellow Y in the first photoreceptors 10Y. The first refractive index distributed rod lenses 20Y are not limited to two rows, but an arbitrary number of at least three rows are also possible.

The first developing section 13Y has a first developing roller 211. The developing roller 21Y supplies a toner for yellow Y to the first photoreceptor 10Y. The electrostatic latent image of the first photoreceptor 10Y is developed using the toner, and a toner image for yellow Y is formed in the first photoreceptor 10Y.

The first photoreceptor cleaner 14Y cleans the first photoreceptor 10Y to which a toner image is transferred.

As illustrated in FIG. 1, the transfer unit 4 includes a first transfer section 22Y for yellow Y, a second transfer section 22M for magenta M, a third transfer section 22C for cyan C, a fourth transfer section 22K for black B, an endless transfer belt 23 that is a transfer medium, a fifth transfer section 24, and a transfer belt cleaner 25.

The first transfer section 22Y has a first transfer roller 26Y. The second transfer section 22M has a second transfer roller 26M. The third transfer section 22C has a third transfer roller 26C. The fourth transfer section 22K has a fourth transfer roller 26K. The first to fourth transfer rollers 26Y, 26M, 26C, and 26K press the transfer belt 23 to the corresponding first to fourth photoreceptors 10Y, 10M, 100, and 10K, and transfers the toner images for the first to fourth photoreceptors 10Y, 10M, 100, and 10K to the transfer belt 23 using the first to fourth transfer biases.

The transfer belt 23 lays on a drive roller 27 and a driven roller 28, and is rotated in the direction γ of an arrow by the drive roller 27.

The fifth transfer section 24 has a fifth transfer roller 29. The fifth transfer roller 29 presses a transfer material to the transfer belt 23, and transfers a toner image of the transfer belt 23 to the transfer material using a fifth transfer bias.

The transfer belt cleaner 25 cleans the transfer belt to which the toner image is transferred.

The transfer material supply unit 5 includes a transfer material accommodating section 5a that accommodates a transfer material such as a transfer paper, and a transfer material supply section 5b that supplies the transfer material from the transfer material accommodating section 5a to the fifth transfer section 24. The transfer material supply unit 5 supplies transfer materials from the transfer material accommodating section 5a to the fifth transfer section 24 one by one during the formation of an image.

The fuser unit 6 has a heating roller 30 and a pressing belt 31. The pressing belt 31 presses the transfer material to which toner image is transferred by the fifth transfer section 24 to the heating roller 30. The heating roller 30 heats a toner image transferred surface of the transfer material. Accordingly, the toner image is fused to the transfer material to form an image in the transfer material.

An engine unit 32 of the image forming apparatus 1 is constituted by the image forming unit 3, the transfer unit 4, the transfer material supply unit 5, and the fuser unit 6.

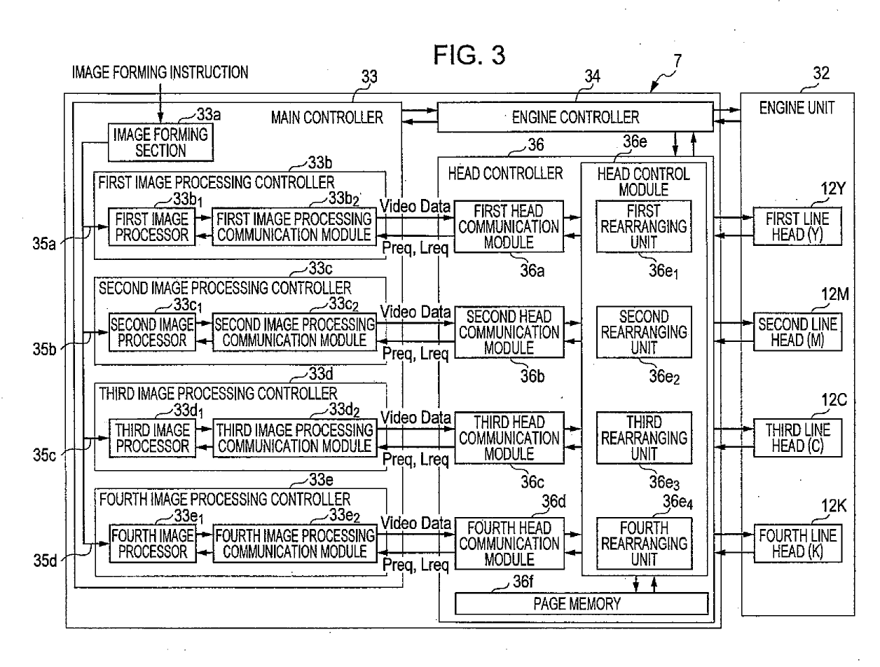

The engine control unit 7 controls the engine unit 32. As illustrated in FIG. 3, the engine control unit 7 has a power source circuit board (not shown), a main controller 33, an engine controller 34, and a head controller 36.

If an image forming instruction is provided from an external device (not shown) such as a host computer, the main controller 33 transmits a control signal for operating the engine unit 32 to the engine controller 34 through a universal asynchronous receiver/transmitter (UART) communication line.

When receiving a control signal from the main controller 33, the engine controller 34 initiates and warms up the engine unit 32. If the engine unit 32 is initiated and warmed up and execution of an image forming operation becomes possible, the engine controller 34 outputs a synchronous signal that triggers start of the image forming operation to the head controller 36 through the UART communication line. Further, in communication between the engine controller 34 and the head controller 36, the transmission and reception of signals of various control parameters for controlling the line heads 11Y, 11M, 11C, and 11K is performed in addition to transmission and reception of the synchronous signal (the transmission and reception of signals of the control parameters is the same as that of the image forming apparatus disclosed in JP-A-2008-137237, and a detailed description thereof will be omitted).

The main controller 33 has an image forming section 33a, a first image processing controller 33b, a second image processing controller 33c, a third image processing controller 33d, and a fourth image processing controller 33e.

When receiving an image forming instruction, the image forming section 33a divides image data contained in the image forming instruction to an arbitrary number of divided data. The divided image data are interleaved image data. The interleaved image data are RGB image (full-colored image) data for red R, green G, and blue B. The divided data are output to the first to fourth image processing controllers 33b, 33c, 33d, and 33e from the first to fourth lanes 35a, 35b, 35c, and 35d.

The first image processing controller 33b has a first image processor 33b₁ and a first image processing module 33b₂. The second image processing controller 33c has a second image processor 33c₁ and a second image processing module 33c₂. The third image processing controller 33d has a third image processor 33d₁ and a third image processing module 33d₂. The fourth image processing controller 33e has a fourth image processor 33e₁ and a fourth image processing module 33e₂.

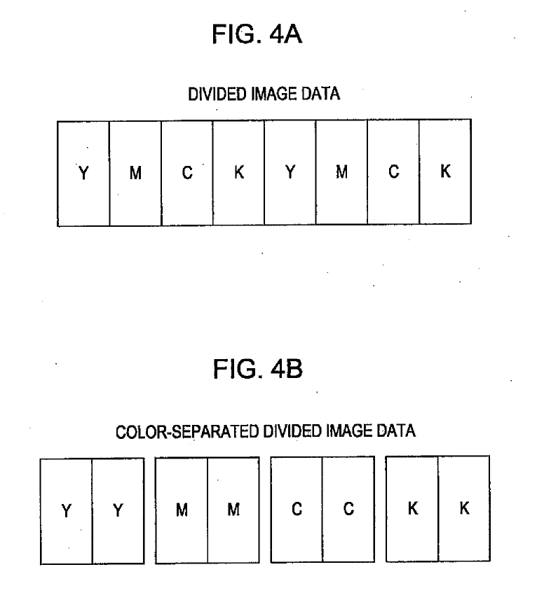

The divided data are input from the image forming section 33a to the first image processor 33b₁, the first image processor 33b₁ processes an image for the supplied divided data. Accordingly, as illustrated in FIG. 4A, the RGB image data become image data in which the RGB image data are color-expanded and merged to the four toner colors of YMCK per pixel. The divided image data contains data of several pixels in one line. The image data of one page are divided in the second direction (sub-scanning direction) in units of several lines so as to be band data, or image data of several pages are divided in units of one page so as to be page data. Therefore, the divided image data do not mean the data divided for the colors of yellow Y, magenta M, cyan C, and black K.

Likewise, if divided data are input to the second to fourth image processors 33c₁, 33d₁, and 33e₁, the second to fourth image processors 33c₁, 33d₁, and 33e₁ processes an image for the supplied divided data. Accordingly, the divided data become image data that are merged to the four toner colors of YMCK. The divided image data contains data of several pixels in one line.

In this way, in the image forming apparatus 1, by providing the four first to fourth image processors 33b₁, 33c₁, 33d₁, and 33e₁, the image data to be printed are divided to a number more than that of the image processors of data and the divided image data are distributed in parallel by the image processors and are image-processed.

The head controller 36 has a first head module 36a, a second head module 36b, a third head module 36c, and a fourth head module 36d. The head controller 36 further includes a head control module 36e and a page memory 36f therein. The page memory 36f may externally be attached to the head controller 36.

The first image processing module 33b₂ and the first head module 36a can bi-directionally communicate with each other. A page request signal Preq representing the head of image data of one page and a line request signal Lreq requiring video data of one line for the image data are transmitted from the first head communication module 36a to the first image processing communication module 33b₂.

The video data for the divided data image-processed by the first image processor 33b₁ are output from the first image processing communication module 33b₂ to the first head communication module 36a. That is, when the first head module 36a outputs the page request signal Preq to the first image processing communication module 33b₂ and outputs the line request signal Lreq, video data are sequentially input through the first image processor 33b₁ from the head of the band data in units of one line.

Likewise, the video data are sequentially input to the second to fourth head modules 36b to 36d through the second to fourth image processing communication modules 33c₂, 33d₂, and 33e₂ in units of one line, starting from the head of the band data image-processed by the second to fourth image processors 33c₁, 33d₁, and 33e₁.

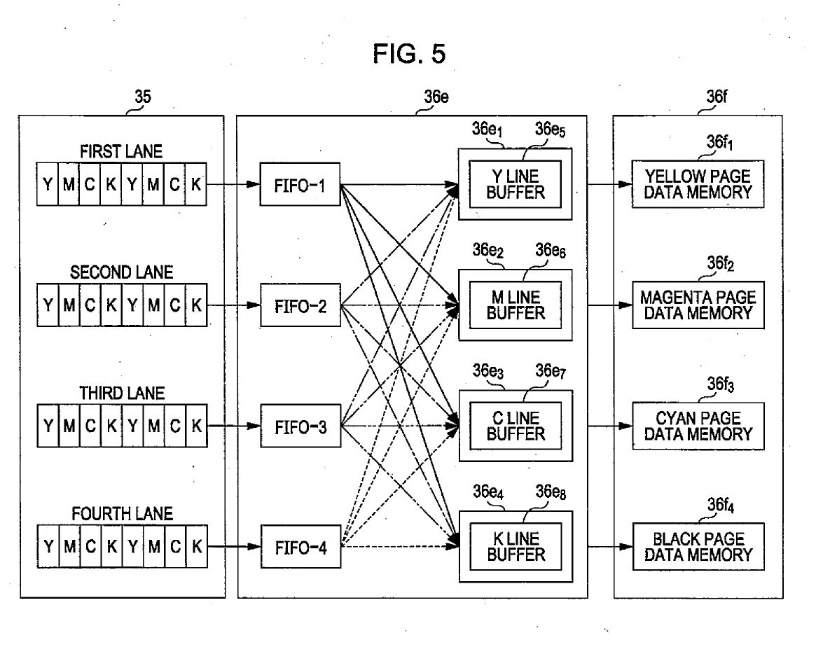

The head control module 36e has a first rearranging unit 36e₁, a second rearranging unit 36e₂, a third rearranging unit 36e₃, and a fourth rearranging unit 36e₄. As illustrated in FIG. 5, the head control module 36e has first to fourth FIFO buffers FIFO-1, FIFO-2, FIFO-3, and FIFO-4. The first to fourth rearranging units 36e₁, 36e₂, 36e₃, and 36e₄ have a Y line buffer 36e₅ for yellow Y, an M line buffer 36e₆ for magenta M, a C line buffer 36e₇ for cyan, and a K line buffer 36e₈ for black K.

In the first lane, the interleaved divided image data are stored in the first FIFO buffer FIFO-1 through the first head communication module 36a. The divided image data stored in the first FIFO buffer FIFO-1 are color-separated as illustrated in FIG. 4B, and are distributed and sequentially stored in the Y line buffer 36e₈, the M line buffer 36e₆, the C line buffer 36e₇, and the K line buffer 36e₈. In the second to fourth lanes, the interleaved different divided image data are stored in the second to fourth FIFO buffers FIFO-2, FIFO-3, and FIFO-4 through the second to fourth head communication modules 36b, 36c, and 36d. The divided image data stored in the second to fourth FIFO buffers FIFO-2, FIFO-3, and FIFO-4 are color-separated, and are distributed and sequentially stored in the Y line buffer 36e₅, the M line buffer 36e₆, the C line buffer 36e₇, and the K line buffer 36e₈.

As illustrated in FIG. 5, the page memory 36f has a yellow page data memory 36f₁, a magenta page data memory 36f₂, a cyan page data memory 36f₃, and a black page data memory 36f₄.

If data for yellow Y corresponding to one line gather in the Y line buffer 36e₅, the line data are transmitted to and stored in the yellow page data memory 36f₁ of the page memory 36f. Likewise, data for magenta M, data for cyan C, and data for black K corresponding to one line gather in the M line buffer, the C line buffer, and the K line buffer 36e₆, 36e 7, and 36e₈, the line data are transmitted to and stored in the magenta page data memory 36f₂, the cyan page data memory 36f₃, and the black page data memory 36f₄ of the page memory 36f.

Then, when line data are transmitted from the line buffers to the page data memories, the data necessary for the line heads are rearranged by the rearranging units so as to be the line data for the colors. The rearranged line data for the colors are transmitted to and stored in the memory addresses corresponding to the page data memories. The head control module 36e extracts the line data for the colors from the page memory 36f depending on the request, and outputs the extracted line data to the first to fourth line heads 12Y, 12M, 12C, and 12K, i.e. the exposure heads for the corresponding colors. Accordingly, the first to fourth line heads 12Y, 12M, 12C, and 12K records the images for the colors in the first to fourth photoreceptors 10Y, 10M, 10C, and 10K depending on the supplied line data.

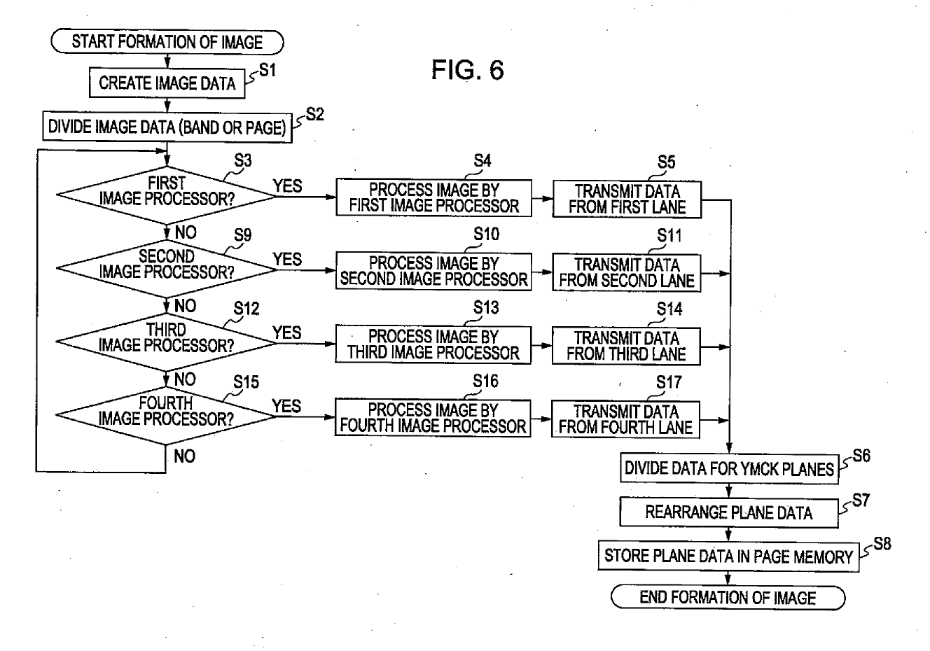

Hereinafter, the flow of forming an image will be described. FIG. 6 is a flowchart illustrating formation of an image.

As illustrated in FIG. 6, first, image data are created by the image forming section 33a in step S1 as formation of an image is started. Next, the image data are divided to band data or page data by the image forming section 33a to form divided data in step S2 (an image data dividing process). Next, the image forming section 33a determines whether or not one divided data can be processed by the first image processor 33b₁ in step S3. If it is determined that the divided data can be processed by the first image processor 33b₁, the divided data is transmitted to the first image processor 33b₁ (a first divided data transmitting process) and is image-processed by the first image processor 33b₁ (a first divided data image processing process) in step S4.

The image-processed divided data are color-expanded to toner colors, and are transmitted to the first FIFO buffer FIFO-1 from the first lane in step S5. Next, the divided data are divided by the first FIFO buffer FIFO-1 for the planes of the colors Y, M, C, and K, and are sent to the line buffers 36e₅, 36e₆, 36e₇, and 36e₈ for the colors in step S6. Next, the plane data are rearranged to the line buffers 36e₅, 36e₆, 36e₇, and 36e₈ by the first rearranging unit 36e₁ in step S7 (a first data rearranging process). The rearranged plane data (line data) are transmitted to the page memory 36f and are stored in the page data memories for the corresponding memory addresses (a data storing process) in step S8. Thereafter, although not illustrated in the flowchart, as described above, the line data for the colors are extracted from the page memory 36f depending on a request of the head control module 36e (a data extracting process), and the images for the colors are recorded in the first to fourth photoreceptors 10Y, 10M, 10C, and 10K depending on the line data extracted by the first to fourth line heads 12Y, 12M, 12C, and 12K (an image forming process). Accordingly, the formation of the image for the image data is completed.

Meanwhile, if it is determined that the divided data cannot be processed by the first image processor 33b₁ in step S3, it is determined whether or not the divided data can be processed by the second image processor 33c₁ in step S9. If it is determined that the divided data can be processed by the second image processor 33c₁, the divided data are transmitted to the second image processor 33c₁ in step S10 (a second divided data transmitting process) and are image-processed by the second image processor 33c₁ (a second divided data image processing process).

The image-processed divided data are transmitted to the second FIFO buffer FIFO-2 from the second lane in step S11. Next, the divided data are divided by the second FIFO buffer FIFO-2 for the planes of the colors Y, M, C, and K, and are sent to the line buffers 36e₅, 36e₆, 36e₇, and 36e₈ for the colors in step S6. Next, the plane data are rearranged to the line buffers 36e₅, 36e₆, 36e₇, and 36e₈ in step S7 (a second data rearranging process). The rearranged plane data (line data) are transmitted to the page memory 36f and are stored in the page data memories for the corresponding memory addresses (a data storing process) in step S8. Thereafter, as described above, the first to fourth line heads 12Y, 12M, 12C, and 12K record the images for the colors in the first to fourth photoreceptors 10Y, 10M, 10C, and 10K depending on the line data extracted by the data extracting process (an image forming process). Accordingly, the formation of the image for the image data is completed.

Meanwhile, if it is determined that the divided data cannot be processed by the second image processor 33c₁ in step S9, it is determined whether or not the divided data can be processed by the third image processor 33d₁ in step S12. If it is determined that the divided data can be processed by the third image processor 33d₁, the divided data are transmitted to the third image processor 33d₁ in step S13 (a third divided data transmitting process) and are image-processed by the third image processor 33d₁ (a third divided data image processing process).

The image-processed divided data are transmitted to the third FIFO buffer FIFO-3 from the third lane in step S14. Next, the divided data are divided by the third FIFO buffer FIFO-3 for the planes of the colors Y, M, C, and K, and are sent to the line buffers 36e₅, 36e₆, 36e₇, and 36e₈ for the colors in step S6. Next, the plane data are rearranged by the line buffers 36e₅, 36e₆, 36e₇, and 36e₈ in step S7 (a third data rearranging process). The rearranged plane data are transmitted to the page memory 36f and are stored in the page data memories for the corresponding memory addresses (a data storing process) in step S8. Thereafter, as described above, the first to fourth line heads 12Y, 12M, 12C, and 12K record the images for the colors in the first to fourth photoreceptors 10Y, 10M, 10C, and 10K depending on the line data extracted by the data extracting process (an image forming process). Accordingly, the formation of the image for the image data is completed.

Meanwhile, if it is determined that the divided data cannot be processed by the third image processor 33d₁ in step S12, it is determined whether or not the divided data can be processed by the fourth image processor 33e 1 in step S15. If it is determined that the divided data can be processed by the fourth image processor 33e₁, the divided data are transmitted to the fourth image processor 33e₁ in step S16 (a fourth divided data transmitting process) and are image-processed by the fourth image processor 33e₁ (a fourth divided data image processing process).

The image-processed divided data are transmitted to the fourth FIFO buffer FIFO-4 from the fourth lane in step S17. Next, the divided data are divided by the fourth FIFO buffer FIFO-4 for the planes of the colors Y, M, C, and K, and are sent to the line buffers 36e₅, 36e₆, 36e₇, and 36e₈ for the colors in step S6. Next, the plane data are rearranged by the line buffers 36e₅, 36e₆, 36e₇, and 36e₈ in step S7 (a fourth data rearranging process). The rearranged plane data are transmitted to the page memory 36f and are stored in the page data memories for the corresponding memory addresses (a data storing process) in step S8. Thereafter, as described above, the first to fourth line heads 12Y, 12M, 12C, and 12K record the images for the colors in the first to fourth photoreceptors 10Y, 10M, 10C, and 10K depending on the line data extracted by the data extracting process (an image forming process). Accordingly, the formation of the image for the image data is completed.

Meanwhile, if it is determined that the divided data cannot be processed by the fourth image processor 33e₁ in step S15, the step returns to step S3 and repeatedly confirms whether or not an image processor that can process the divided data exists until the divided data can be processed.

As described above, according to the image forming apparatus 1, input image data are divided into at least two data. Then, when image data are divided into two data, first divided data are image-processed by the first image processor 33b₁. Second divided data are image-processed by the second image processor 33c₁. Meanwhile, when image data are divided into three data, first divided data are image-processed by the first image processor 33b₁. Second divided data are image-processed by the second image processor 33c₁. Third divided data are image-processed by the third image processor 33d₁. Meanwhile, when image data are divided into at least four data, first divided data, i.e. some of the at least four divided data are image-processed by the first image processor 33b₁. Second divided data, i.e. some of the at least four divided data are image-processed by the second image processor 33c₁. Third divided data, i.e. some of the at least four divided data are image-processed by the third image processor 33d₁. Fourth divided data, i.e. some of the at least four divided data are image-processed by the fourth image processor 33e₁. An image is formed based on the image-processed divided data.

Therefore, the divided data obtained by dividing image data can be distributed when being image-processed. Accordingly, the image data of a high resolution and a high capacity can more promptly be image-processed. In particular, a high speed image forming engine can process an image in real time. Thus, the image forming apparatus can flexibly cope with various resolutions and effectively achieve a higher speed in processing an image.

Since the other structures and image operations of the image forming apparatus 1 are substantially the same as those of the image forming apparatus of JP-A-2008-137237, a detailed description thereof will be omitted.

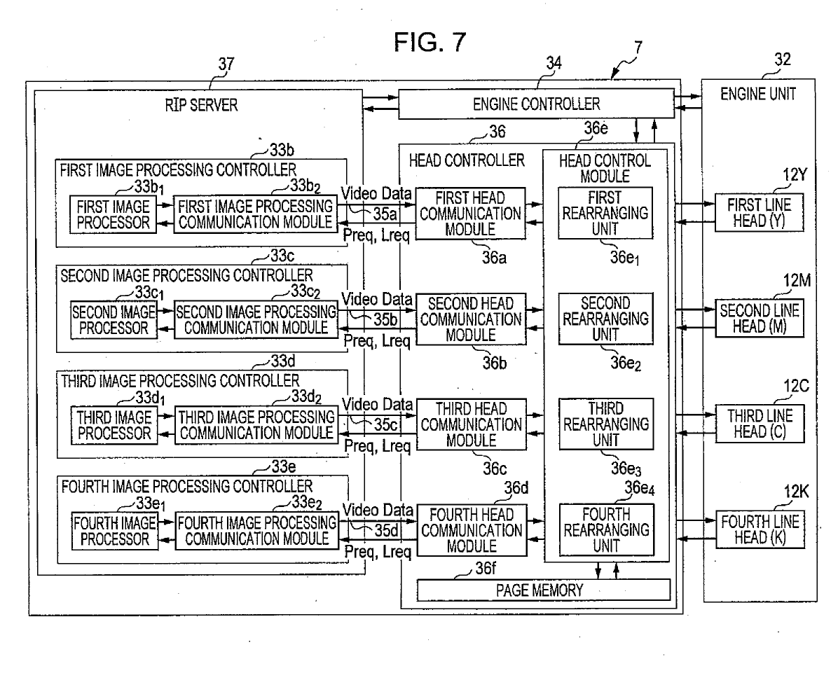

FIG. 7 is a block diagram of an engine control unit and an engine unit in an image forming apparatus according to another embodiment of the invention.

In the first embodiment of the invention, the first to fourth image processing controllers 33b, 33c, 33d, and 33e are provided in the main controller 33. Meanwhile, in the image forming apparatus 1 according to the second embodiment of the invention, as illustrated in FIG. 7, first to fourth image processing controllers 33b, 33c, 33d, and 33e are provided in a raster image processing (RIP) server 37.

Accordingly, the image data stored in advance in the RIP server 37 are image-processed as described above by the first to fourth image processors 33b₁, 33c₁, 33d₁, and 33e₁ and are output to a head controller 36e. The head controller 36e rearranges the image data supplied as described above and stores the rearranged image data in a page memory 36f. The head controller 36e extracts the image data stored in the page memory 36f as described above, and outputs the extracted image data to first to fourth line heads 12Y, 12M, 12C, and 12K. Accordingly, the first to fourth line heads 12Y, 12M, 12C, and 12K form an electrostatic latent image in the first to fourth photoreceptors 10Y, 10M, 10C, and 10K based on the supplied image data.

The structure, operation, and effect of the image forming apparatus 1 according to the second embodiment of the invention are substantially the same as those of the image forming apparatus according to the second embodiment of the invention.

The present invention is not limited to the above-described embodiments, but may variously be modified within the scope of the claims.

The entire disclosure of Japanese Patent Application No: 2008-274647, filed Oct. 24, 2008 is expressly incorporated by reference herein.

What is claimed is:

1. An image forming method comprising:
dividing input image data;
transmitting first divided data to a first image processing unit;
transmitting second divided data to a second image processing unit;
image-processing the first divided data transmitted to the first image processing unit;
image-processing the second divided data transmitted to the second image processing unit; and
forming an image based on the first divided data image-processed by the first image processing unit and the second divided data image-processed by the second image processing unit.

2. The method according to claim 1, further comprising:
rearranging the first divided data image-processed by the first image processing unit; and
rearranging the second divided data image-processed by the second image processing unit,
wherein, in forming an image, the image is formed based on the rearranged first divided data and the rearranged second divided data.

3. The method according to claim 2, further comprising:
storing the rearranged first divided data and the rearranged second divided data in a memory unit; and
retrieving the rearranged first divided data and the rearranged second divided data stored in the memory unit.

4. An image forming apparatus comprising:
a latent image carrier on which a latent image is formed;
an exposure head that forms the latent image on the latent image carrier; and
a controller that includes a division unit dividing an input image data, a first image processing unit image-processing a first divided data, a second image processing unit image-processing a second divided data, and an output unit outputting the image-processed first divided data and the image-processed second divided data to the exposure head.

5. The image forming apparatus according to claim 4, wherein the controller further includes a first rearranging unit rearranging the first divided data image-processed by the first image processing unit and a second rearranging unit rearranging the second divided data image-processed by the second image processing unit, and the rearranged first divided data and the rearranged second divided data are output to the exposure head.

6. The image forming apparatus according to claim 5, wherein the controller further includes a memory unit in which the rearranged first divided data and the rearranged second divided data are stored, and the rearranged first divided data and the rearranged second divided data stored in the memory unit are retrieved and output to the exposure head.

7. An image forming system comprising:
an RIP server that divides and stores an input image data and includes a first image processing unit image-processing the first divided data and a second image processing unit image-processing the second divided data; and
an image forming apparatus that includes a latent image carrier on which a latent image is formed, an exposure head forming the latent image on the latent image carrier, and a controller outputting the first divided data supplied from the RIP server and the second divided server supplied from the RIP server to the exposure head.

8. The image forming system according to claim 7, wherein the controller includes a first rearranging unit rearranging the first divided data image-processed by the first image processing unit and a second rearranging unit rearranging the second divided data image-processed by the second image processing unit.
